(19) United States
(12) Patent Application Publication
(10) Pub. No.: US 2017/0280635 A1
(43) Pub. Date: Oct. 5, 2017

(54) Raised Bed Garden and Micro Greenhouse System

(71) Applicant: Eric Hayes Petty, Fort Collins, CO (US)

(72) Inventor: Eric Hayes Petty, Fort Collins, CO (US)

(21) Appl. No.: 15/474,367

(22) Filed: Mar. 30, 2017

Related U.S. Application Data
(60) Provisional application No. 62/315,188, filed on Mar. 30, 2016.

(51) Int. Cl. A01G 9/10; A01G 9/26; A01G 9/12; A01G 9/16; B29C 49/48; A01G 9/02; A63H 33/32; A01G 9/14

(52) U.S. Cl. CPC A01G 9/10; A63H 33/32; A01G 9/26; A01G 9/1407; A01G 9/1438; A01G 9/16; B29C 49/4802; A01G 9/026; A01G 9/12; B29C 2049/4807; B29K 2023/06; B29L 2031/7006

(57) ABSTRACT

A raised bed garden and sandbox system comprised of rails and connectors, where the rails are connected to each other via a hinge-like system and joined by the insertion of tubular connectors that are circular in cross-section and open at one end to allow the insertion of a framework for a cover. A structure to support a cover is described, consisting of multiple cross-members, where one end of each cross-member is inserted into a connector and the other end of the cross-member is inserted into the opposite connector. An alternative design for a structure to support a cover is described, where for each cross-member one end is inserted into a connector and the other end is inserted into a central hub. A pattern is described to ensure that the raised bed garden or sandbox is arranged into a regular polygon. A heating element consisting of an electrical resistor arranged in a plane is described, as well as an planar insulator sized to fit the raised bed garden. An improvement in the design of a blow-molded rail provides higher quality and shorter cycle time by forming a partial bushing in the male end of the rail instead of a full bushing.

### CROSS-REFERENCE TO RELATED APPLICATIONS

I claim under 35 U.S.C. §119(e) the benefit of the previously filed provisional application RAISED BED GARDEN AND MICRO GREENHOUSE SYSTEM, U.S. 62/315,188 filed on Mar. 30, 2016.

### STATEMENT REGARDING FEDERALLY SPONSORED RESEARCH OR DEVELOPMENT

Not Applicable.

### REFERENCE TO SEQUENCE LISTING, A TABLE, OR A COMPUTER PROGRAM LISTING COMPACT DISC APPENDIX

Not Applicable.

### BACKGROUND OF THE INVENTION

Raised bed gardens have been used for centuries as a method to achieve higher yields while utilizing the same amount of gardening space. Historically, raised beds have typically been made of wood, stone, or man-made materials such as cinder blocks, resulting in raised beds which are time-consuming and difficult to construct. Additionally, raised beds made of wood have a very limited lifetime.

Cold frames and hot houses have been used to extend gardening seasons by providing a covered environment for plants, but these systems are typically difficult and expensive to construct.

The objective of this invention was to create a raised bed garden and micro greenhouse system that would be quick and easy to construct, and would allow gardeners to extend their gardening seasons and protect their plants from insects and animals.

An improvement in the art was generated by U.S. Pat. No. 6,202,367 and EP 1,020,109 which provided for a bracket system which utilizes wooden or synthetic timbers to create a raised bed garden. However, this invention requires significant assembly by the gardener, suffers from poor and leaky joints, and the stacking mechanism for creating higher raised bed gardens creates a structure that is more rickety than solid.

U.S. Pat. No. 6,434,882 demonstrates a typical raised bed garden with cold frame. This inventions suffers the typical problems of this type of design, including an inability to make the area of the raised bed garden larger or smaller, or make the walls higher. Designs of this type typically break under a heavy snow load. Additionally, the design provides no protection for plants when they grow too tall for the cold frame structure.

The present invention seeks to overcome all of these issues with a flexible system that allows the gardener to create the size and shape garden desired and provide protection to his plants during all seasons of the year.

### BRIEF SUMMARY OF THE INVENTION

The present invention describes the manufacture and use of a customizable raised bed garden and micro greenhouse system. The components of the invention include rails for holding soil or sand, connectors of various lengths for joining the rails, patterns to ensure the rails are placed in the proper geometric alignment, soil heaters and insulators, and structures to support various covers and plant supports.

Raised bed gardens have long been recognized as the best gardening method because of several factors. Raised beds prevent compaction of the soil, provide greater soil depth, and allow the gardener to utilize soil of his choice. Raised beds heat up and drain more quickly than the surrounding ground. Some raised beds can be used as a platform to support a framework with can be covered with greenhouse film to create a cold frame or micro greenhouse, allowing an extended growing season.

Many different designs for raised bed gardens have been utilized. Raised beds constructed of wood are typical, such as used by Thomas Jefferson at Monticello. Wooden beds have a limited life span, as the wood eventually rots and becomes unusable. Stone or brick are sometimes used, but these beds are difficult to construct and more difficult to move. More recently, plastic and metal connectors have become available which allow fairly rapid construction of raised beds with wooden or plastic sides.

This invention regards a raised bed garden consisting of rails that can be combined with connectors to easily create raised bed gardens or sandboxes of various sizes and heights. A pattern is provided to allow the user to easily create a regular polygon, ensuring a consistent shape and allowing easy addition of additional parts. Insulation and an in-soil heater with a thermostat are used to ensure that the soil is at the proper temperature regardless of the season. Different structural frameworks insert into the connectors to allow the raised bed garden to be covered with materials that protect against cold, hail, deer, or insects. Frameworks designed for use in summer and fall allow the user to grow crops vertically on strings.

The preferred method of implementing the invention is to blow mold the rails out of high density polyethylene resin, producing a product that will last for decades. Blow molding is a manufacturing method where a hollow tube (parison) of material is extruded and allowed to drop between the sides of a mold. The mold is closed and air is blown into the parison, which then expands to completely fill the mold with material. After the material cools, the mold is opened and the part released.

This invention also regards the construction of the rails used in the raised bed garden system by using blow molding to form a partial bushing, which allows easy insertion and alignment of the connectors while also optimizing manufacturing cycle time and cost.

### BRIEF DESCRIPTION OF THE DRAWINGS

FIG. 1 is a perspective view of a raised bed garden rail.

FIG. 2 is a sectional view of the end of FIG. 1 (full bushing).

FIG. 3 is a sectional view of the end of FIG. 1 (partial bushings).

FIG. 4 is a perspective view of a connector.

FIG. 5 is a perspective view of a pattern for a pentagon garden or sandbox.

FIG. 6 is a perspective view of a double pentagon raised bed garden installed on the pattern of FIG. 5.

FIG. 7 is a perspective view of a hub for a square raised bed garden.

FIG. 8 is a perspective view of a piece of insulation for a square raised bed garden.

FIG. 9 is a perspective view of a heater.

FIG. 10 is a perspective view of a square micro greenhouse with insulation.

FIG. 11 is a perspective view of a square raised bed garden with a summer framework

### DETAILED DESCRIPTION OF THE INVENTION

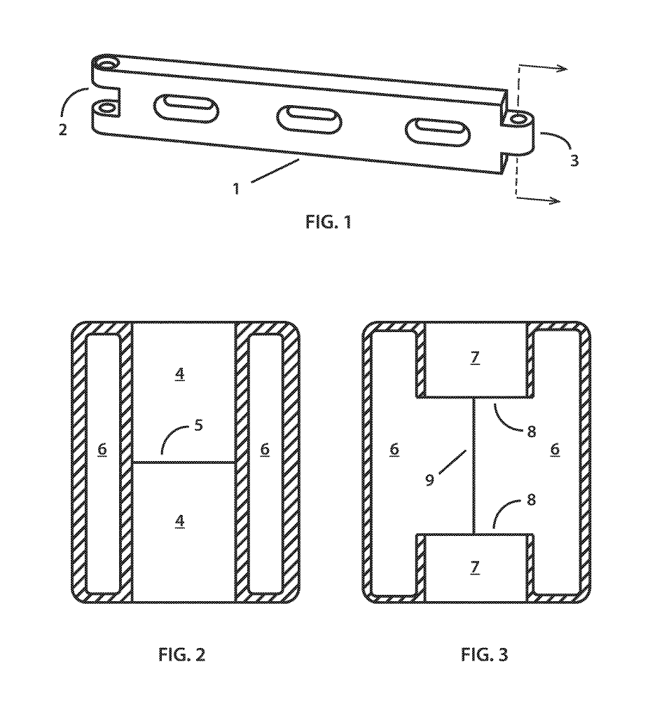

FIG. 1 is a perspective view of a raised bed garden rail 1. It has a male end 3 and a female end 2 which allow the rails to be connected end-to-end and the combined rails to form any angle between 90 and 270 degrees.

FIG. 2 shows a cross-sectional view of the male end 3 of rail 1. A bushing 4 is constructed in the rail 1 by use of a secondary action in the mold. After the mold closes on the parison and air is blown into the parison two cylinders are activated and move to form the bushing 4. The cylinders meet at the action parting line 5. The inside surface 6 of the outer wall of the rail 1 is visible in the section. After blow molding rail 1 the flashing at the parting line 5 is removed with a hole saw to create a single bushing that passes all the way through the male end 3 of rail 1.

Similar actions are used at the female end 2 of rail 1 to form bushings during the blow molding, and the flashing later removed with a hole saw.

The bushings allow a tight and easy fit of the connectors, ensure alignment between different rails, and with a connector help to push the rails together to create a tight fit between rails and minimize gaps.

It is more difficult to manufacture the rails with bushings than without. If the moving cylinders that form the bushings tear the parison as they move, the part suffers a “blow out” and is not properly formed. Manufacture of the bushings requires that more material be present so that the material can be stretched to form the bushing without tearing. Formation of the bushings 4 requires more material than is necessary for mechanical stability and structural strength.

Additional material (a thicker parison) requires a longer time to cool in the mold, and is more susceptible to warping as the part cools. Thus in general formation of a rail with bushings requires a longer cycle time and produces a worse fit than a rail produced without bushings.

The benefits of the bushings can be maintained and the disadvantages eliminated by forming two partial bushings that do not directly connect.

FIG. 3. shows a cross-section of the male end 3 of rail 1 where partial bushings 7 are formed. Because the bushings are not fully formed, more of the inside surface 6 of the outer wall of rail 1 is visible in the section, as well as the mold parting line 9. The cylinders that form the partial bushings 7 do not meet, but stop their movement at 8, the partial bushing flashing. After blow molding the rail, the partial bushing flashings 8 are removed by a hole saw to allow a connector to be inserted through the male end 3 of rail 1.

The formation of partial bushings 7 instead of a full bushing 4 allows the rail 1 to be formed with a thinner parison and less material. This results in decreased warping and decreased cycle time, with consequent improvements in product quality and cost.

The partial bushings 7 can be manufactured by designing the mold as such. A mold designed to manufacture full bushings 4 can be utilized by modifying the actuators which move the cylinders to limit their stroke length.

The preferred method of implementing the invention is to utilize cylinders to form the partial bushings 7 that are shorter than the cylinders used to form the full bushing 4. In this method, the cylinders begin the manufacture depressed into the side of the mold, with the parison forced into the depression by air pressure after the mold is closed. The cylinders are then activated and move to form the partial bushings 7.

This preferred method produces superior results even though it violates the blow molding principle to never reverse the flow of material. By pooling material in the depressions caused by withdrawing the cylinders below the surface of the mold, the cylinders have more material to stretch and the rail 1 can be made with thinner walls and a shorter cycle time.

This method of blowing the parison into a depression formed by beginning manufacture with the cylinders withdrawn below the surface of the mold may be used to form full bushings 4 and is superior to the previously described methods.

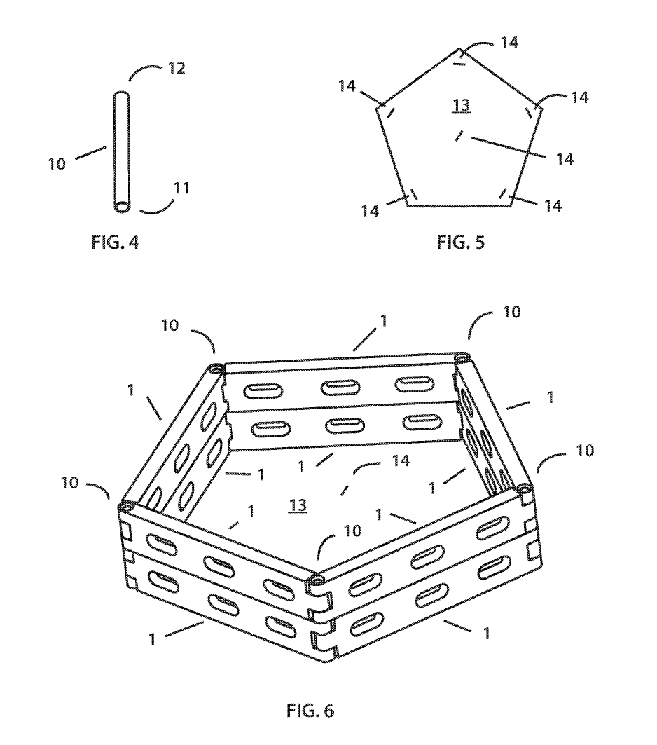

FIG. 4 shows a connector 10, comprised of a chamfered end 11 and an open end 12. Connector 10 is hollow inside. Connectors 10 are constructed of various lengths, so that any number of rails may be stacked upon each other to create a raised bed garden of any height. The preferred method of implementing the invention is to extrude the connectors 10 using high density polyethylene, cut to length, and then chamfer one end 11 by sanding or milling. Connector 4 can also be manufactured by injection molding, molding in the chamfer 11, but a separate mold will be required for each different length of connector 10. Alternatively, connector 10 could also be manufactured by blow molding followed by sawing off end 12, but separate molds will still be required for each different length of connector 10.

The ability of the joint between the male end 3 and the female end 2 of rails 1 to rotate between 90 and 270 degrees combined with the ability to join any number of rails 1 together allows the user to create an infinite number of different polygons with four or more sides. Because all forces are symmetrical, rails 1 arranged into a regular polygon (square, pentagon, hexagon, heptagon, octagon, etc.) will hold their shape. Rails 1 arranged into an irregular polygon such as a rectangle will not hold their shape unless stakes are driven into the ground through the center of connectors 10.

The addition of structural elements or covers to raised bed gardens and sandboxes requires that the distance between different elements and the overall shape is constant for each installation. Many alternative methods exist to ensure that rails 1 are arranged in a perfect polygon. One method is to create a form which constrains the angle between two rails 1 to create the desired polygon. This method would require a different form for each polygon, the desired form would probably be bulky, and the form would probably require expensive custom tooling to produce. Another method is to contain the distance between the centers of connectors 10. In a hexagon, this can be achieved by creating an apparatus consisting of two pegs connected by a precise length of wire. Three of these apparatuses placed in opposite connectors 10 will constrain six rails 1 unto a perfect hexagon shape in theory but in practice is somewhat difficult to use.

FIG. 5. shows the preferred method of implementing the invention and creating a perfect polygon, which is to use a pattern 13. The pattern 13 is placed on the ground and held in place by landscape staples 14. Rails 1 are then arranged so that they are on the edge of the pattern and then connected with connectors 10. In general, biodegradable patterns 13 are preferred for raised bed gardens and non-biodegradable patterns 13 are preferred for sandboxes.

FIG. 6 shows a double pentagon raised bed garden with ten rails 1 arranged into two pentagons stacked one atop the other, using pattern 13 to achieve a perfect pentagon shape. Note that the preferred method of implementing the invention is for the male ends 3 and the female ends 2 of the two pentagons to point in opposite directions.

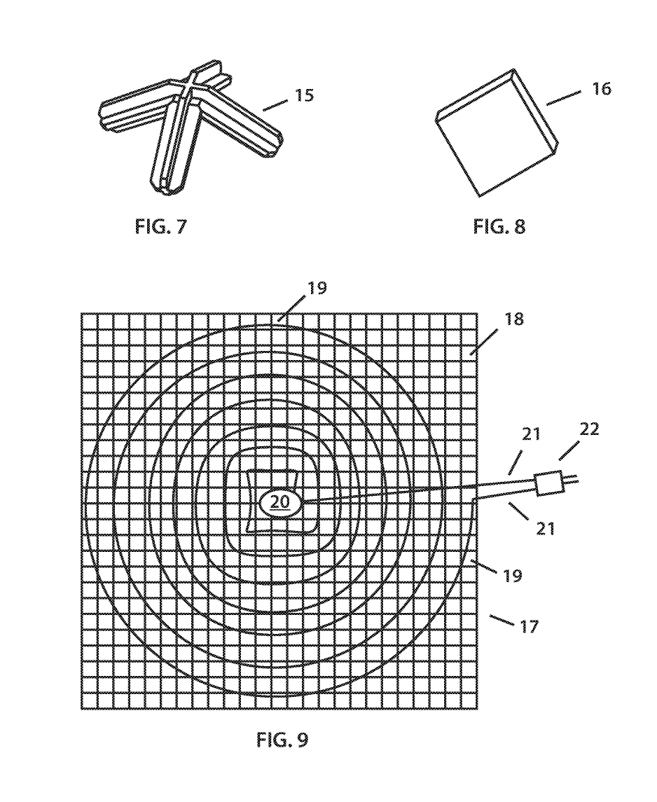

FIG. 7 shows a hub 15 used to connect four equal lengths of flexible polyethylene irrigation tubing 23. The other ends of the four lengths of flexible polyethylene irrigation tubing 23 are inserted into the four connectors 10 holding together four rails 1 to form a square micro greenhouse structure. Polyethylene sheeting for protection against cold and snow, hail protection, or insect protection can be easily attached to the tubing structure using garden clips or other methods.

The hub 15 is necessary for polygons with an odd number of sides (e.g., pentagon, heptagon, etc.). The hub 15 is not necessary for polygons with an even number of sides (e.g., square, hexagon, etc.). In the example of a hexagon, three sections of flexible polyethylene irrigation tubing may create a covering structure by inserting each end of a section of tubing into the opposite connectors 10 in a hexagon raised bed garden. In the preferred method of implementing this invention without using hub 15, a hole is drilled in the center of each length of tubing and the pieces of tubing connected where hub 15 would otherwise be with a length of zip tie.

FIG. 8 shows a square piece of insulation 16, four of which can be combined to insulate a square raised bed garden from the ground. Four square pieces of insulation 16 are used instead of one piece so that any excess water can properly drain from the raised bed.

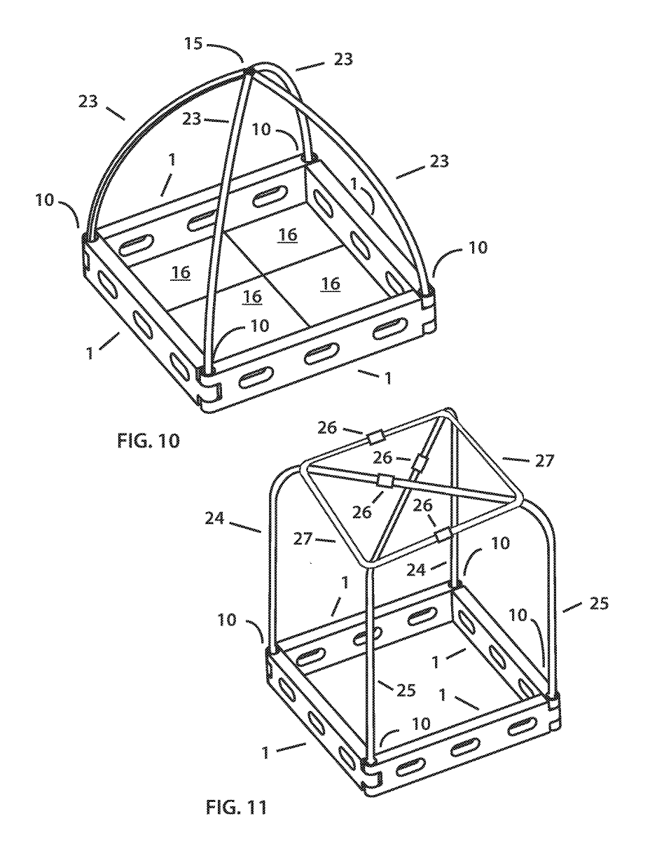

FIG. 9 shows a heater 17 for a square raised bed garden. The heater 17 is comprised of a supporting structure 18 to which is attached a circuit comprised of insulated heating wire 19, a thermostat 20, regular insulated wire 21, and a plug 22. In the preferred method of implementing the intention, the supporting structure 18 is comprised of a polyethylene “hardware cloth.” Alternatively, supporting structure 18 can be composed of metal, but any implementation must allow water to drain through. The wiring elements are attached to each other with waterproof connections. The heating wire 19 is attached to the supporting structure 18 using hot melt glue or zip ties. Alternatively, the heating wire 19 and thermostat 20 are sandwiched between two supporting structures 18 of polyethylene “hardware cloth” and fused together.

FIG. 10 shows a preferred implementation of this invention for use in the winter and spring. Four rails 1 and four connectors 10 are used to create a square raised bed garden. Four pieces of insulation 16 are placed on the bottom of the raised bed garden and against the ground. Four pieces of polyethylene irrigation tubing 23 are placed inside the four connectors 10 and theirs ends connected with hub 15.

This square micro greenhouse can be covered with greenhouse film or other coverings using standard garden clips or other methods. Heater 17 may be placed on top of the pieces of insulation 16 to ensure that the soil added to the raised bed garden will maintain the desired temperature, and allow gardening throughout the year. The when covered with clear polyethylene greenhouse film, the dome shape of the structure will equally distribute the forces of a snow load, allowing the user to garden even in the fiercest winter climates.

A preferred implementation of this invention for use in the summer and fall is shown in FIG. 11. A square raised bed garden is constructed using four rails 1 and four connectors 10. Rigid electrical conduit is cut to length and bent to a 90 degree angle using a pipe bender to create two vertical supports with short horizontals 24 and two vertical supports with long horizontals 25. A vertical support with short horizontal 24 and a vertical support with long horizontal 25 are inserted into connectors 10 in opposite corners, and connected with a compression coupling 26. A second vertical support with short horizontal 24 and a second vertical support with long horizontal 25 are inserted into the two open connectors 10, and connected with a compression coupling 26. Rigid electrical conduit is cut to length and bent twice to a 90 degree angle using a pipe bender to create a top support half 27. A second top support half 27 is created and joined to the first top support half 27 with compression couplings 26 to create a top support, which is placed on top of vertical supports 24 and 25. The top support can be attached to the vertical supports using zip ties if desired.

This framework of rigid electrical conduit can be covered with anti-hail netting, insect netting, shade cloth, or any other water-permeable material and secured with garden clips. Strings may be tied to the horizontal elements of the structure to allow easy trellising of plants.

As the winter framework described in FIG. 10 and the summer framework described in FIG. 11 are easily removed from the raised bed garden, the user can utilize different frameworks depending on the season or the specific crop grown. Hot weather varieties such as tomatoes, peppers, eggplant, and cucumbers can be started several weeks earlier by utilizing an insulated raised bed garden with a heater and winter cover. As the plants grow larger and the weather warms up, the user can remove the winter cover and replace it with a summer cover, providing more room for the plants and the ability to trellis the plants using string.

I claim:

1. A device for containing soil or sand, comprised of rails and connectors,
said rails having an elongated vertical wall member with opposite vertical side surfaces, first and second opposite ends, and elongated top and bottom surfaces, with connecting means for hingedly connecting each end of said rail to another similar rail, and
said connectors having a tubular shape and roughly circular cross-section, being hollow inside and open at one end.

2. The device of claim 1, wherein said connector is open at both ends.

3. The device of claim 1, wherein said connector is chamfered.

4. The device of claim 1, wherein said connector is open at both ends and chamfered.

5. A raised bed garden or sandbox system comprised of rails, connectors, and a pattern,
said rails having an elongated vertical wall member with opposite vertical side surfaces, first and second opposite ends, and elongated top and bottom surfaces, with connecting means for hingedly connecting each end of said rail to another similar rail,
said connectors fitting inside the hingedly connecting means of two or more rails and joining them together hingedly, and
said pattern being in the shape of a regular polygon and sized to fit inside or underneath a set of rails and connectors.

6. A hollow rail for containing soil or sand, comprising,
an elongated vertical wall member with opposite vertical side surfaces, first and second opposite ends, and elongated top and bottom surfaces, with connecting means for hingedly connecting each end of said rail to another similar rail,
with one end having one hinge element and the opposite end having two hinge elements,
and with the hinge element on the end having only one hinge element having a vertical hole with an integrated bushing,
said bushing extending only partially into the vertical hole from both ends.

7. The device of claim 6, wherein said rail is manufactured by blow-molding.

8. The device of claim 6, wherein said rail is hollow when first manufactured and then filled with another substance.

9. A method for manufacturing a rail comprising an elongated vertical wall member with opposite vertical side surfaces, first and second opposite ends, and elongated top and bottom surfaces, with connecting means for hingedly connecting each end of said rail to another similar rail, comprised of the steps of:
a mold closing around a parison of material,
the material being blown against the edges of the mold by air pressure,
connecting means formed by an action in the mold which moves to create a walled vertical bore, said action moving before, during, or after the air pressure blows the material against the edges of the mold,
with the action moving only part way into the bore, such that the interior wall of the bore extends only partly into the bore from either end.

10. A framework to support a cover for a raised bed garden or sandbox, comprising,
a set of cross-members, each with two ends, where one end of each cross-member inserts into the connector at a corner of the raised bed garden or sandbox, and the other end of each cross-member inserts into the connector at the far opposite corner of the raised bed garden or sandbox, so that the cross-members all cross each other above a point near the center of the raised bed garden or sandbox.

11. The device of claim 10, wherein said cross-members consist of a hollow tube that is roughly circular in cross-section.

12. The device of claim 10, wherein said cross-members are constructed of extruded polyethylene.

13. The device of claim 10, wherein each cross-member has a hole extending through the approximate middle of each cross-member.

14. The device of claim 10, wherein the raised bed garden or sandbox is comprised of rails and connectors, said rails having an elongated vertical wall member with opposite vertical side surfaces, first and second opposite ends, and elongated top and bottom surfaces, with connecting means for hingedly connecting each end of said rail to another similar rail, and said connectors having a tubular shape and roughly circular cross-section, being hollow inside and open at one end.

15. A framework to support a cover for a raised bed garden or sandbox, comprising,
a set of cross-members, each with two ends, where one end of each cross-member inserts into the connector at a corner of the raised bed garden or sandbox, and the other end of each cross-member inserts into a common hub.

16. The device of claim 13, wherein said cross-members consist of a hollow tube that is roughly circular in cross-section.

17. The device of claim 13, wherein said cross-members are constructed of extruded polyethylene.

18. The device of claim 13, wherein the raised bed garden or sandbox is comprised of rails and connectors, said rails having an elongated vertical wall member with opposite vertical side surfaces, first and second opposite ends, and elongated top and bottom surfaces, with connecting means for hingedly connecting each end of said rail to another similar rail, and said connectors having a tubular shape and roughly circular cross-section, being hollow inside and open at one end.

19. A heated raised bed garden system, comprised of rails, connectors, and a heater,
said rails having an elongated vertical wall member with opposite vertical side surfaces, first and second opposite ends, and elongated top and bottom surfaces, with connecting means for hingedly connecting each end of said rail to another similar rail,
said connectors fitting inside the hingedly connecting means of two or more rails and joining them together hingedly, and
said heater consisting of an electrical resistance heating element arrayed in a plane and sized to fit inside a set of rails and connectors arranged in the shape of a regular polygon.

20. The device of claim 19, wherein said heater includes an integrated thermostat.

21. An insulated, heated, raised bed garden system, comprised of rails, connectors, a heater, and insulation,
said rails having an elongated vertical wall member with opposite vertical side surfaces, first and second opposite ends, and elongated top and bottom surfaces, with connecting means for hingedly connecting each end of said rail to another similar rail,
said connectors fitting inside the hingedly connecting means of two or more rails and joining them together hingedly,
said insulation comprised of one or more sheets of insulating material which fit together to cover the inside bottom of a set of rails and connectors arranged in the shape of a regular polygon,
said heater consisting of an electrical resistance heating element arrayed in a plane and sized to fit inside a set of rails and connectors arranged in the shape of a regular polygon.

22. The device of claim 21, wherein said heater includes an integrated thermostat.
